(19) United States
(12) Patent Application Publication
(10) Pub. No.: US 2025/0002370 A1
(43) Pub. Date: Jan. 2, 2025

(54) POSITIVE ELECTRODE MATERIAL FOR LITHIUM ION SECONDARY BATTERY AND PREPARATION METHOD THEREFOR

(71) Applicants: MURATA MANUFACTURING CO., LTD., Kyoto (JP); Xiamen University, Fujian (CN)

(72) Inventors: Yong YANG, Fujian (CN); Xiaozhen ZHANG, Fujian (CN); Yixiao LI, Fujian (CN); Yuli LI, Shanghai (CN); Li WANG, Shanghai (CN); Kazumasa TAKESHI, Shanghai (CN)

(21) Appl. No.: 18/676,091

(22) Filed: May 28, 2024

(30) Foreign Application Priority Data
Jun. 30, 2023 (CN) 2023107978692

(51) Int. Cl. C01G 53/00; H01M 4/525

(52) U.S. Cl. CPC C01G 53/50; H01M 4/525; C01P 2002/54; C01P 2002/85; C01P 2004/03; C01P 2004/04; C01P 2004/62; C01P 2004/64; C01P 2006/40

(57) ABSTRACT

The present application provides a positive electrode material for a lithium ion secondary battery and a preparation method therefor. The positive electrode material for a lithium ion secondary battery comprises polycrystalline particles of a ternary positive electrode material and a modifying material. The polycrystalline particles comprise a plurality of primary particles. The modifying materials are located on the surface of the polycrystalline particles and/or at the grain boundary interfaces between the primary particles, wherein the modifying material comprises an oxide of a positive pentavalent or positive hexavalent transition metal. By using the positive electrode material for a lithium ion secondary battery and the preparation method therefor of the present application, the problem of cracking of secondary particles of the material during the circulation process is avoided. Thus, the mechanical strength and structural stability of the ternary positive electrode material are effectively improved, and at the same time, the high-temperature cycle stability of the ternary positive electrode material is significantly improved, and the impedance increase during the cycle of the lithium ion secondary battery prepared thereby is effectively reduced.

### INCORPORATION BY REFERENCE

This application claims the benefit of Chinese Patent Application No. 2023107978692, filed on Jun. 30, 2023, and titled “Positive electrode material for lithium ion secondary battery and preparation method therefor”, the entire contents of which are incorporated by reference herein.

### TECHNICAL FIELD

The present application relates to the field of lithium ion secondary batteries, and in particular, to a positive electrode material for a lithium ion secondary battery and a preparation method therefor.

### BACKGROUND

In recent years, with the continuous development of electronic technologies, the demand for battery devices used to support the energy supply of electronic equipment has also been increasing. Nowadays, there is a need for batteries that can store more energy and output high power. Conventional lead-acid batteries, nickel-hydrogen batteries, and the like have been unable to meet the needs of new electronic products. Therefore, metal batteries have attracted wider attention. In the development of metal batteries, the capacity and properties thereof have been improved more effectively. In the prior art, metal batteries include lithium ion batteries, non-anode batteries, lithium metal batteries, sodium metal batteries, sodium ion batteries, potassium metal batteries, potassium ion batteries, magnesium metal batteries, magnesium ion batteries, zinc ion batteries, zinc metal batteries, and the like. Among them, lithium metal batteries have been widely developed and used because of their excellent electrochemical properties and cycle retention.

In a currently used lithium ion secondary battery, the positive electrode material generally comprises lithium cobaltate (LiCoO₂), a ternary material (LiNiₓCo_{y}Mn_{1-x-y}O₂, NCM), lithium ferrite (LiFePO₄), nickel cobalt aluminum oxide (NCA), and a sulfide (Li—S). Lithium cobaltate is a relatively mature, stable and reliable positive electrode material, and can provide high capacity and long cycle life, but has the disadvantages of high price and potential safety hazard. Lithium ferrite has good safety, is not prone to detonation in situations such as overcharge, over-discharge and impact, and has a long service life. However, the energy density is too low and the volume is too large. The advantage of the sulfide as a positive material is that it has a large storage capacity and can theoretically achieve a very high energy density. However, the cycle life thereof is short, and in practical applications, problems such as structural mismatch and various reaction products need to be solved. Nickel cobalt aluminum oxide is widely used in automobile batteries, and has good electrical conductivity and durability, but has high costs. A more common positive electrode material in the prior art is a ternary positive electrode material, which has a higher energy density and power density, and has a relatively long cycle life. However, the ternary positive electrode material, especially a nickel cobalt lithium manganate material, still has the problems of particle breakage caused by insufficient mechanical strength and inadequate electric properties in use.

In order to solve the disadvantages of ternary positive electrode materials, the existing technology usually adopts a method of modifying ternary positive electrode materials, such as lithium nickel cobalt manganate, to provide better properties. For example, in one type of method, the ternary positive material can be placed in a gas atmosphere of tungsten oxide, and tungsten oxide is deposited on the surface of the ternary positive electrode material by cooling, thereby forming a monocrystalline ternary positive electrode material coated with metal tungsten oxide in the gas phase. In another type of method, a precursor of a ternary positive electrode material can be first mixed with a lithium source, and then calcined to obtain a monocrystalline structure nickel-rich ternary positive electrode material; and then the single crystal structure nickel-rich ternary positive electrode material is mixed with a tungsten source, sintered, and cooled to obtain a tungsten-coated and doped monocrystalline nickel-rich ternary positive electrode material.

However, these methods in the prior art can only modify the ternary positive electrode material having a monocrystalline structure, and cannot modify the ternary positive electrode material having a polycrystalline structure. In addition, the technological processes of the methods in the prior art are relatively complex. Because tungsten oxide has a relatively high melting point (about 1837° C.), obtaining a tungsten oxide gas atmosphere requires heating to a very high temperature. Therefore, the dependence on energy consumption is high, and the costs are high during large-scale industrial production. In a method using a secondary sintering process, a tungsten source is added during the secondary sintering, and the improvement of the electrochemical properties of the ternary positive electrode material is not obvious. Therefore, there is a need to develop a positive electrode material for a lithium ion secondary battery and a preparation method therefor to improve disadvantages in the prior art.

### SUMMARY

A main object of the present application is to provide a positive electrode material for a lithium ion secondary battery and a preparation method therefor, so as to solve the problem that the methods in the prior art cannot effectively modify ternary positive electrode materials, thereby obtaining desired electrical properties and mechanical properties.

In order to achieve the described object, according to one aspect of the present application, provided is a positive electrode material for a lithium ion secondary battery, comprising: polycrystalline particles of a ternary positive electrode material, containing a plurality of primary particles; and a modifying material located on the surface of the polycrystalline particles and/or at the grain boundary interfaces between the primary particles, wherein the modifying material comprises an oxide of a positive pentavalent or positive hexavalent transition metal.

Further, in the described positive electrode material, the modifying material comprises tungsten oxide, niobium oxide, or molybdenum oxide.

Further, in the described positive electrode material, the primary particles have a particle size of 400 nm or less.

Further, in the described positive electrode material, the average particle size of the primary particles is in the range of 250 nm to 350 nm.

Further, in the described positive electrode material, the ternary positive electrode material has a chemical general formula LiNiₓCo_{y}Mn_{1-x-y}O₂, wherein 0.8≤x<1, 0<y<1, and 0<x+y<1; and preferably 0.9≤x<1, 0<y<1, and 0<x+y<1.

Further, in the described positive electrode material, the doping depth of the modifying material is in the range of about 0 nm to about 20 nm.

Further, in the described positive electrode material, the doping amount of the transition metal in the positive electrode material is in the range of about 0.25 atom % to about 2.1 atom %, based on the total number of atoms of the positive electrode material.

According to another aspect of the present application, provided is a method for preparing a positive electrode material for a lithium ion secondary battery, comprising the following steps: step S1, subjecting a lithium source, a ternary positive electrode material precursor, and a modifying material to primary sintering, wherein the modifying material comprises an oxide of a positive pentavalent or positive hexavalent transition metal; step S2, grinding the product after the primary sintering, and subjecting the ground product to secondary sintering, wherein the temperature of the primary sintering is lower than the temperature of the secondary sintering.

Further, in the described method, the precursor of the ternary positive electrode material is [NiₓCo_{y}Mn_{1-x-y}](OH)₂, wherein 0.8≤x<1, 0<y<1, and 0<x+y<1; and preferably 0.9≤x<1, 0<y<1, and 0<x+y<1.

Further, in the described method, the modifying material comprises tungsten oxide, niobium oxide, or molybdenum oxide.

Further, in the described method, the molar ratio of the ternary positive electrode material precursor to the modifying material is in the range of 100:0.25 to 100:2.0.

Further, in the described method, the primary sintering is carried out at a temperature in the range of about 450° C. to about 600° C. for about 4 to about 7 hours, and oxygen gas is introduced at a flow rate of about 80 ml/min to about 150 ml/min during the primary sintering.

Further, in the described method, the secondary sintering is carried out at a temperature in the range of about 700° C. to about 800° C. for about 12 to about 20 hours, and oxygen gas is introduced at a flow rate of about 80 ml/min to about 150 ml/min during the secondary sintering.

Further, in the described method, the lithium source comprises lithium hydroxide or lithium carbonate.

Further, in the described method, the molar ratio of the precursor of the ternary positive electrode material to the lithium source is in the range of 1:1 to 1:1.2.

By means of the positive electrode material for a lithium ion secondary battery and the preparation method therefor of the present application, the problem of cracking of secondary particles in the cycle process is avoided, thereby effectively improving the mechanical strength and structural stability of the ternary positive electrode material, and at the same time, significantly improving the high-temperature cycle stability of the ternary positive electrode material and effectively reducing the impedance increase of the lithium ion secondary battery prepared thereby in the cycle process.

### BRIEF DESCRIPTION OF THE DRAWINGS

The accompanying drawings, which form a part of the present application, are used to provide a further understanding of the present application. The schematic examples of the present application and the description thereof are used to explain the present application, and do not form improper limits to the present application. In the drawings:

FIG. 1A, 1B, 1C, 1D, 1E, 1F, 1G, 1H, and 11 respectively show the SEM image of the positive electrode material according to Examples 1 to 9 of the present application, wherein FIG. 1A: NCM 98+0.25% WO₃, FIG. 1B: NCM 98+0.5% WO₃, FIG. 1C: NCM 98+1.0% WO₃, FIG. 1D: NCM 98+1.5% WO₃, FIG. 1E: NCM 98+2.0% WO₃, FIG. 1F: NCM 98+1.0% MoO₃, FIG. 1G: NCM 98+1.0% Nb₂O₅, FIG. 1H: NCM 811+0.5% WO₃, and FIG. 1I: NCM 92+0.5% WO₃.

FIG. 2 shows the SEM image of the positive electrode material of Comparative Example 1 (NCM 98).

FIG. 3 shows the results of XPS test of the positive electrode material according to Example 3 of the present application at different etching depths.

FIG. 4A and 4B show the STEM-EDS elemental line scan results of the positive electrode material according to Example 3 of the present application.

FIG. 5 shows the measurement results of the primary particle size distribution of the positive electrode material according to Example 3 of the present application.

FIG. 6 shows the measurement results of the primary particle size distribution of the positive electrode material of Comparative Example 1.

FIG. 7 shows the measurement results of the hardness according to Example 3 and Comparative Example 1 of the present application.

FIG. 8 shows the SEM image of a cross section of the positive electrode material according to Example 3 of the present application after 100 cycles.

FIG. 9 shows the SEM image of a cross section of the positive electrode material of Comparative Example 1 after 100 cycles.

FIG. 10 shows the increase in the charge transfer impedance of the battery according to Example 3 of the present application after 100 cycles.

FIG. 11 shows the increase in the charge transfer impedance of the battery of Comparative Example 1 after 100 cycles.

### DETAILED DESCRIPTION OF THE EMBODIMENTS

It is important to note that the examples of the present application and the characteristics in the examples can be combined under the condition of no conflicts. The present application will be described below with reference to the drawings and examples in detail.

As explained in the background art, the methods in the prior art cannot effectively modify the ternary positive electrode materials to obtain desired electrical and mechanical properties. Therefore, there is still a need to improve the methods for preparing ternary positive electrode materials in the prior art. In view of the problems in the prior art, according to a typical embodiment of the present application, a positive electrode material for a lithium ion secondary battery is provided, The positive electrode material comprises polycrystalline particles of a ternary positive electrode material and a modifying material, wherein the polycrystalline particles comprise a plurality of primary particles, the modifying material is located on the surface of the polycrystalline particles and/or at the grain boundary interfaces between the primary particles, and the modifying material comprises an oxide of a positive pentavalent or positive hexavalent transition metal. In a preferred embodiment, the modifying material of the present application comprises tungsten oxide, niobium oxide, or molybdenum oxide.

In the present application, a ternary positive electrode material comprises polycrystalline particles. As is known in the art, polycrystalline particles refer to structures consisting of many primary particles, each having its own lattice and orientation. In the ternary positive electrode material of the present application, the ternary positive electrode material first forms primary particles, and then a plurality of the primary particles are agglomerated to form polycrystalline particles. The different grains (the primary particles in the polycrystalline particles) may contact each other and form interfaces. The interfaces formed are the grain boundary interfaces between the primary particles of the polycrystalline particles. In the present application, the grain boundary interfaces are divided into internal grain boundaries and surface grain boundaries. The internal grain boundaries are connected by structural units (the primary particles) with different directions or orientations, and exist throughout the polycrystalline particles of the ternary positive electrode material. The surface grain boundaries are edge regions created when reactions occur between the external environment and the material surface. In the present application, the surface grain boundaries are grain boundary surface of the polycrystalline particles.

The use of an unmodified polycrystalline material (a ternary positive electrode material) in the prior art causes the following problems: 1) intercrystalline or intracrystalline cracks in the polycrystalline material: during the charging and discharging process, the stress concentration inside the material particles caused by H2-H3 phase transformation will lead to intercrystalline or intracrystalline cracks in the material during the battery cycle, which will lead to the decline of the material properties; 2) the interfacial degradation of the polycrystalline material: during charging and discharging of a battery, as a side reaction occurs, particles of the polycrystalline material will be inevitably broken, and after the material is broken and damaged, the electrolyte solution will enter the interior of the positive electrode material, which will cause more side reactions between the positive electrode material and the electrolyte solution, and exacerbate the degradation of the properties of the positive electrode material; 3) decrease of the thermal stability: for an ultra-high-nickel positive electrode material, side reactions between the ultra-high-nickel positive electrode material and the electrolyte solution will not only affect the electrical properties of the material, but also the thermal stability of the positive electrode material will gradually deteriorate along with the increase of the nickel content.

In order to avoid the described problems, in the positive electrode material of the present application, the modifying material containing an oxide of a positive pentavalent or positive hexavalent transition metal is concentrated on the surface of polycrystalline particles and at the grain boundary interfaces between the primary particles. By adopting such a structure, the size, morphology and microstructure of the primary particles (single grains) of the positive electrode material are changed, and finally, a ternary positive electrode material refined and densely packed from the primary particles is obtained. In addition, the size of the primary particles is refined and the primary particles are densely packed by introducing a high-valent (positive pentavalence or positive hexavalence) transition metal element such as tungsten, niobium, or molybdenum, and thus the microstructure of the material is effectively changed. The structure can effectively relieve the volume change of the ternary positive electrode material during lithium ion deintercalation, and the lower volume change avoids the problem of cracking of secondary particles during the cycle, thereby effectively improving the mechanical strength and structural stability of the ternary positive electrode material, and the high-temperature cycle stability of the ternary positive electrode material is further significantly improved and the impedance increase during the cycle of the lithium ion secondary battery prepared therefrom is effectively reduced.

In some embodiments of the present application, the primary particles have a particle size of about 400 nm or less, preferably, the primary particles have a particle size of about 100 nm to about 400 nm; and the average particle size of the primary particles is in the range of about 250 nm to about 350 nm. The ternary positive electrode material is composed of primary particles having a particle size of about 400 nm or less. The particle size of the primary particles may vary as desired, but should not exceed the scope of the present application. For different examples, the particle size of the ternary positive electrode material may be in the range of about 400 nm or less, about 300 nm or less, about 200 nm or less, about 100 nm or less, about 50 nm or less, about 100 nm to about 400 nm, about 110 nm to about 390 nm, about 120 nm to about 380 nm, about 130 nm to about 370 nm, about 140 nm to about 360 nm, about 150 nm to about 350 nm, about 160 nm to about 340 nm, about 170 nm to about 330 nm, about 180 nm to about 320 nm, about 190 nm to about 310 nm, about 200 nm to about 300 nm, about 210 nm to about 290 nm, about 220 nm to about 280 nm, about 230 nm to about 270 nm, about 240 nm to about 260 nm, about 100 nm to about 350 nm, about 100 nm to about 300 nm, about 100 nm to about 250 nm, about 100 nm to about 200 nm, about 100 nm to about 150 nm, about 150 nm to about 400 nm, about 200 nm to about 400 nm, about 250 nm to about 400 nm, about 300 nm to about 400 nm, about or 350 nm to about 400 nm. In addition, in the described particle size range, the average particle size of the primary particles may be in the range of 250 nm to about 350 nm, about 260 nm to about 340 nm, about 270 nm to about 330 nm, about 280 nm to about 320 nm, or about 290 nm to about 310 nm.

In some embodiments of the present application, the primary particles have an average particle size in the range of about 250 nm to about 350 nm. For different examples, The average particle size of the primary particles may be in the range of about 250 nm to about 350 nm, about 260 nm to about 340 nm, about 270 nm to about 330 nm, about 280 nm to about 320 nm, about 290 nm to about 310 nm, about 250 nm to about 340 nm, about 250 nm to about 330 nm, about 250 nm to about 320 nm, about 250 nm to about 310 nm, about 250 nm to about 300 nm, about 250 nm to about 290 nm, about 250 nm to about 280 nm, about 250 nm to about 270 nm, about 250 nm to about 260 nm, about 260 nm to about 350 nm, about 270 nm to about 350 nm, about 280 nm to about 350 nm, about 290 nm to about 350 nm, about 300 nm to about 350 nm, about 310 nm to about 350 nm, about 320 nm to about 350 nm, about 330 nm to about 350 nm, or about 340 nm to about 350 nm.

In some embodiments of the present application, the ternary positive electrode material has a chemical general formula LiNiₓCo_{y}Mn_{1-x-y}O₂, wherein 0.8≤x<1, 0<y<1, and 0<x+y<1; and preferably 0.9≤x<1, 0<y<1, and 0<x+y<1. When the described general formula is used, the main ternary positive electrode material of the positive electrode material of the present application is a high-nickel positive electrode material. In the present application, the high-nickel positive electrode material contains a higher content of nickel element. Generally, a high-nickel positive electrode material has a nickel content of 50% or more. However, in the present application, the high-nickel positive electrode material used has a nickel content of 80% or more, and preferably 90% or more. When a high-nickel positive electrode material is used, the positive electrode material of the present application will have a higher energy density, and thus can provide improved electrical properties for a lithium ion secondary battery. The high-nickel positive electrode material has good chemical stability, so that when the high-nickel positive electrode material is not in use, a low self-discharge rate is maintained, and therefore, problems such as loss and aging do not occur easily. When the modified high-nickel positive electrode material according to the present application is used as a positive electrode material for a lithium ion secondary battery, excellent properties are exhibited during repeated charge and discharge, and the stability can be maintained even when the temperature changes.

In some embodiments of the present application, the doping depth of the high-valent element contained in the modifying material is in the range of about 0 nm to about 20 nm in the positive electrode material. In the present application, the modifying material is located on the surface of the polycrystalline particles and/or at the grain boundary interfaces of the primary particles, and when the modifying material is only present on the surface of the polycrystalline particles, the doping depth thereof is 0 nm. When the modifying material is present on the surface of the polycrystalline particles and at the grain boundary interfaces between the primary particles, it may be located at a depth of up to about 20 nm of the ternary positive electrode material. For different examples, the doping depth of the high-valent element contained in the modifying material in the positive electrode material may be in the range of about 0 nm to about 20 nm, about 0 nm to about 19 nm, about 0 nm to about 18 nm, about 0 nm to about 17 nm, about 0 nm to about 16 nm, about 0 nm to about 15 nm, about 0 nm to about 14 nm, about 0 nm to about 13 nm, about 0 nm to about 12 nm, about 0 nm to about 11 nm, about 0 nm to about 10 nm, about 0 nm to about 9 nm, about 0 nm to about 8 nm, about 0 nm to about 7 nm, about 0 nm to about 6 nm, about 0 nm to about 5 nm, about 0 nm to about 4 nm, about 0 nm to about 3 nm, about 0 nm to about 2 nm, or about 0 nm to about 1 nm.

In various embodiments of the present application, the doping amount of the transition metal in the positive electrode material is in the range of about 0.25 atom % to about 2.1 atom %, based on the total number of atoms of the positive electrode material. For different examples, the doping amount of the modifying material may be in the range of about 0.25 atom % to about 2.1 atom %, about 0.25 atom % to about 2.0 atom %, about 0.3 atom % to about 1.9 atom %, about 0.35 atom % to about 1.8 atom %, about 0.4 atom % to about 1.7 atom %, about 0.45 atom % to about 1.6 atom %, about 0.5 atom % to about 1.5 atom %, about 0.6 atom % to about 1.4 atom %, about 0.7 atom % to about 1.3 atom %, about 0.8 atom % to about 1.2 atom %, about 0.9 atom % to about 1.1 atom %, about 0.25 atom % to about 1.5 atom %, about 0.25 atom % to about 1.0 atom %, about 0.25 atom % to about 0.5 atom %, about 0.3 atom % to about 2.1 atom %, about 0.35 atom % to about 2.1 atom %, about 0.4 atom % to about 2.1 atom %, about 0.45 atom % to about 2.1 atom %, about 0.5 atom % to about 2.1 atom %, about 0.6 atom % to about 2.1 atom %, about 0.7 atom % to about 2.1 atom %, about 0.8 atom % to about 2.1 atom %, about 0.9 atom % to about 2.1 atom %, about 1.0 atom % to about 2.1 atom %, or about 1.5 atom % to about 2.1 atom %.

According to another typical embodiment of the present application, provided is a method for preparing a positive electrode material for a lithium ion secondary battery. The method comprises the following steps: step S1, subjecting a lithium source, a ternary positive electrode material precursor and a modifying material to primary sintering, wherein the modifying material comprises an oxide of a positive pentavalent or positive hexavalent transition metal; and step S2, grinding the product after the primary sintering, and subjecting the ground product to secondary sintering, wherein the temperature of the primary sintering is lower than the temperature of the secondary sintering.

In the method of the present application, a secondary sintering process is used to prepare the polycrystalline particles. Different from the vapor deposition method in the prior art or the preparation method in which a tungsten source is added in the secondary sintering process, in the method of the present application, a modifying material is first added in a high temperature lithiation process (primary sintering) of the ternary positive electrode material precursor, the high-valent oxide contained in the modifying material is doped on the surface of the polycrystalline particles of the ternary positive electrode material and/or at the grain boundary interfaces between the primary particles. In this way, the size, morphology, and microstructure of the primary particles of the ternary positive electrode material are changed, and finally, a ternary positive electrode material in which the primary particles are refined and densely packed is obtained. The positive electrode material prepared by the method of the present application effectively changes the microstructure of the material, and the structure can effectively relieve the volume change of the ternary positive electrode material during lithium ion deintercalation, and the lower volume change avoids the problem of cracking of the secondary particles during the cycle, and thus the mechanical strength and structural stability of the ternary positive electrode material are effectively improved, and futher, the high-temperature cycle stability of the ternary positive electrode material is significantly improved and the impedance increase during the cycle of the lithium ion secondary battery prepared therefrom is effectively reduced.

In some embodiments of the present application, the ternary positive electrode material has a chemical general formula LiNiₓCo_{y}Mn_{1-x-y}O₂, wherein 0.8≤x<1, 0<y<1, and 0<x+y<1; preferably 0.9≤x<1, 0<y<1, and 0<x+y<1, and the ternary positive electrode material precursor is [NiₓCo_{y}Mn_{1-x-y}](OH)₂, wherein 0.8≤x<1, 0<y<1, and 0<x+y<1; and preferably 0.9≤x<1, 0<y<1, and 0<x+y<1. When the described general formula is used, the main ternary positive electrode material of the positive electrode material of the present application is a high-nickel positive electrode material. In the present application, the high-nickel positive electrode material contains a higher content of nickel element. Generally, a high-nickel positive electrode material has a nickel content of about 50% or more. However, in the present application, the high-nickel positive electrode material used has a nickel content of about 80% or more, and preferably about 90% or more. When a high-nickel positive electrode material is used, the positive electrode material of the present application will have a higher energy density, and thus can provide improved electrical properties for a lithium ion secondary battery. The high-nickel positive electrode material has good chemical stability, so that when the high-nickel positive electrode material is not in use, a low self-discharge rate is maintained, and therefore, problems such as loss and aging do not occur easily. When the modified high-nickel positive electrode material of the present application is used as a positive electrode material for a lithium ion secondary battery, excellent properties are exhibited during repeated charge and discharge, and the stability can be maintained even when the temperature changes.

In the present application, the modifying material of the ternary positive electrode material used for modification includes, but is not limited to, tungsten oxide, niobium oxide, or molybdenum oxide. By introducing an oxide of a high-valent transition metal tungsten, niobium, or molybdenum, the size of the primary particles is refined and the primary particles are densely packed, thereby effectively changing the microstructure of the material.

In some embodiments of the present application, the molar ratio of the ternary positive electrode material precursor to the modifying material is in the range of 100:0.25 to 100:2.0. Within this range, the modifying material may effectively form a modifying material positioned on the surface of the grain boundaries of the polycrystalline particles and/or at the grain boundary interfaces between the primary particles in the primary sintering process. For different examples, the molar ratio of the ternary positive electrode material precursor to the modifying material may be in the range of 100:0.25 to 100:1, 100:0.3 to 100:0.9, 100:0.35 to 100:0.8, 100:0.4 to 100:0.7, 100:0.45 to 100:0.6, 100:0.25 to 100:0.9, 100:0.25 to 100:0.8, 100:0.25 to 100:0.7, 100:0.25 to 100:0.6, 100:0.25 to 100:0.5, 100:0.25 to 100:0.4, 100:0.25 to 100:0.3, 100:0.3 to 100:1, 100:0.35 to 100:1, 100:0.4 to 100:1, 100:0.45 to 100:1, 100:0.5 to 100:1, 100:0.55 to 100:1, 100:0.6 to 100:1, 100:0.65 to 100:1, 100:0.7 to 100:1, 100:0.75 to 100:1, 100:0.8 to 100:1, 100:0.85 to 100:1, 100:0.9 to 100:1, 100:0.95 to 100:1, 100:0.25 to 100:2.0, 100:0.25 to 100:1.9, 100:0.25 to 100:1.8, 100:0.25 to 100:1.7, 100:0.25 to 100:1.6, 100:0.25 to 100:1.5, 100:0.25 to 100:1.4, 100:0.25 to 100:1.3, 100:0.25 to 100:1.3, or 100:0.25 to 100:1.1.

In a further embodiment of the present application, the primary sintering may be carried out at a temperature in the range of about 450° C. to about 600° C. for about 4 to about 7 hours, and oxygen gas is introduced at a flow rate of about 80 ml/min to about 150 ml/min during the primary sintering. In the present application, the sintering temperature, the sintering time, and the amount of oxygen gas introduced for the primary sintering may be separately selected. In various embodiments, the sintering temperatures of the primary sintering may be in the range of 450° C. to about 600° C., about 460° C. to about 590° C., about 470° C. to about 580° C., about 480° C. to about 570° C., about 490° C. to about 560° C., about 500° C. to about 550° C., about 510° C. to about 540° C., about 520° C. to about 530° C., about 450° C. to about 580° C., about 450° C. to about 560° C., about 450° C. to about 540° C., about 450° C. to about 520° C., about 450° C. to about 500° C., about 450° C. to about 480° C., about 450° C. to about 460° C., about 470° C. to about 600° C., about 490° C. to about 600° C., about 510° C. to about 600° C., about 530° C. to about 600° C., about 550° C. to about 600° C., about 570° C. to about 600° C., or about 590° C. to about 600° C. The sintering time for the primary sintering process may be selected from the following ranges: about 4 to about 7 hours, about 4.5 to about 6.5 hours, about 5 to about 6 hours, about 4.5 to about 7 hours, about 5 to about 7 hours, about 5.5 to about 7 hours, about 6 to about 7 hours, about 6.5 to about 7 hours, about 4 to about 6.5 hours, about 4 to about 6 hours, about 4 to about 5.5 hours, about 4 to about 5 hours, or about 4 to about 4.5 hours. The flow rate of oxygen gas introduced during the primary sintering process may be in the range of about 80 ml/min to about 150 ml/min, about 90 ml/min to about 140 ml/min, about 100 ml/min to about 130 ml/min, about 110 ml/min to about 120 ml/min, about 80 ml/min to about 140 ml/min, about 80 ml/min to about 130 ml/min, about 80 ml/min to about 120 ml/min, about 80 ml/min to about 110 ml/min, about 80 ml/min to about 100 ml/min, about 80 ml/min to about 90 ml/min, about 90 ml/min to about 150 ml/min, about 100 ml/min to about 150 ml/min, about 110 ml/min to about 150 ml/min, about 120 ml/min to about 150 ml/min, about 130 ml/min to about 150 ml/min, or about 140 ml/min about 150 ml/min.

In some embodiments, the secondary sintering is carried out at a temperature in the range of about 700° C. to about 800° C. for about 12 to about 20 hours, and oxygen gas is introduced at a flow rate of about 80 ml/min to about 150 ml/min during the secondary sintering. In the present application, the sintering temperature, the sintering time, and the amount of oxygen gas introduced for the secondary sintering may be separately selected. In various embodiments, the sintering temperature of the secondary sintering may be in the range of about 700° C. to about 800° C., about 710° C. to about 790° C., about 720° C. to about 780° C., about 730° C. to about 770° C., about 740° C. to about 760° C., about 710° C. to about 800° C., about 720° C. to about 800° C., about 730° C. to about 800° C., about 740° C. to about 800° C., about 750° C. to about 800° C., about 760° C. to about 800° C., about 770° C. to about 800° C., about 780° C. to about 800° C., about 790° C. to about 800° C., about 700° C. to about 790° C., about 700° C. to about 780° C., about 700° C. to about 770° C., about 700° C. to about 760° C., about 700° C. to about 750° C., about 700° C. to about 740° C., about 700° C. to about 730° C., about 700° C. to about 720° C., or about 700° C. to about 710° C. The sintering time for the secondary sintering process may be in the range of about 12 to about 20 hours, about 13 to about 19 hours, about 14 to about 18 hours, about 15 to about 17 hours, about 12 to about 19 hours, about 12 to about 18 hours, about 12 to about 17 hours, about 12 to about 16 hours, about 12 to about 15 hours, about 12 to about 14 hours, about 12 to about 13 hours, about 13 to about 20 hours, about 14 to about 20 hours, about 15 to about 20 hours, about 16 to about 20 hours, about 17 to about 20 hours, about 18 to about 20 hours, or 19 to about 20 hours. The flow rate of oxygen gas introduced during the secondary sintering may be in the range of about 80 ml/min to about 150 ml/min, about 90 ml/min to about 140 ml/min, about 100 ml/min to about 130 ml/min, about 110 ml/min to about 120 ml/min, about 80 ml/min to about 140 ml/min, about 80 ml/min to about 130 ml/min, about 80 ml/min to about 120 ml/min, about 80 ml/min to about 110 ml/min, about 80 ml/min to about 100 ml/min, about 80 ml/min to about 90 ml/min, about 90 ml/min to about 150 ml/min, about 100 ml/min to about 150 ml/min, about 110 ml/min to about 150 ml/min, about 120 ml/min to about 150 ml/min, about 130 ml/min to about 150 ml/min, or about 140 ml/min to about 150 ml/min.

In the method of the present application, any substance capable of providing a lithium element may be used as the lithium source, and a preferred lithium source includes lithium hydroxide (lithium hydroxide monohydrate) or lithium carbonate.

In further embodiments of the present application, the molar ratio of the ternary positive electrode material precursor to the lithium source is in the range of 1:1 to 1:1.2. For various examples, the molar ratio of the ternary positive electrode material precursor to the lithium source is in the range of 1:1 to 1:1.2, 1:11 to 1:1.19, 1:12 to 1:1.18, 1:13 to 1:1.17, 1:14 to 1:1.16, 1:1 to 1:1.19, 1:1 to 1:1.18, 1:1 to 1:1.17, 1:1 to 1:1.16, 1:1 to 1:1.15, 1:1 to 1:1.14, 1:1 to 1:1.13, 1:1 to 1:1.12, 1:1 to 1:1.11, 1:11 to 1:1.2, 1:12 to 1:1.2, 1:13 to 1:1.2, 1:14 to 1:1.2, 1:15 to 1:1.2, 1:16 to 1:1.2, 1:17 to 1:1.2, 1:18 to 1:1.2, or 1:19 to 1:1.2.

The present application will be further described in detail in conjunction with the following specific examples, and these examples should not be construed as limiting the scope of protection of the present application.

### EXAMPLE 1

### Preparation of the Positive Electrode Material

3 g of Ni_{0.98}Co_{0.01}Mn_{0.01}(OH)₂ precursor, 1.47 g of lithium hydroxide monohydrate (the molar ratio of the precursor to lithium hydroxide monohydrate=1:1.06), and 0.0188 g of tungsten oxide (WO₃, the molar ratio of the precursor to tungsten oxide is 100:0.25) were mixed homogenously in an agate mortar. Firstly, the mixture was subjected to sintering in a tube furnace at 500° C. for 5 h at a heating rate of 3° C./min, and highly pure oxygen was introduced at an oxygen flow rate of 100 mL/min. After the primary sintering was completed, the temperature was naturally reduced, and when the furnace temperature was reduced to room temperature, the material after the primary sintering was removed. The material after the primary sintering was ground in an agate mortar for 5 min, and placed again in a tube furnace at 720° C. for sintering for 15 h, with the heating rate being 3° C./min and the oxygen flow being 100 mL/min. After the secondary sintering was finished, the temperature was naturally cooled, and when the furnace body was cooled to room temperature, the material subjected to the secondary sintering was removed, ground in an agate mortar for 5 min, and then sealed and transferred to a glove box for storage, so as to obtain a positive electrode material.

### Preparation of a Battery

### Preparation of a Positive Electrode

0.2125 g of the foregoing prepared positive electrode material and 0.0175 g of a graphite conductive agent were dispersed in 0.4 g of N-methylpyrrolidone (containing 5% of polyvinylidene fluoride) to obtain a positive electrode mixture slurry. Subsequently, the positive electrode mixture slurry was coated on an aluminum foil to obtain a positive electrode current collector. The positive electrode current collector was dried by baking at 110° C. for 1 hour. After rolling, a stamping process was used to cut the positive electrode current collector into small disc-shaped positive electrode sheets of 11.3 mm.

### Preparation of an Electrolyte Solution

15.0 g of ethylene carbonate, 70.0 g of dimethyl carbonate, and 15.0 g of lithium hexafluorophosphate were mixed to prepare an electrolyte solution.

### Assembly of a Battery

A 2032 button cell was assembled in the glove box. The positive electrode sheet prepared in the foregoing steps was used as the positive electrode, and the negative electrode sheet is made of lithium metal. The positive electrode, the negative electrode, the separator, and the button cell were assembled, and the electrolyte solution was injected. After the battery was assembled, the battery was allowed to stand for about 5 h aging, so as to obtain a lithium cobalt nickel manganate button battery.

### EXAMPLE 2

### Preparation of a Positive Electrode Material

3 g of Ni_{0.98}Co_{0.01}Mn_{0.01}(OH)₂ precursor, 1.47 g of lithium hydroxide monohydrate (the molar ratio of the precursor to lithium hydroxide monohydrate=1:1.06), and 0.0376 g of tungsten oxide (WO₃, the molar ratio of the precursor to tungsten oxide is 100:0.5) were mixed homogenously in an agate mortar. Firstly, the mixture was subjected to sintering in a tube furnace at 500° C. for 5 h at a heating rate of 3° C./min, and highly pure oxygen was introduced at an oxygen flow rate of 100 mL/min. After the primary sintering was completed, the temperature was naturally reduced, and when the furnace temperature was reduced to room temperature, the material after the primary sintering was removed. The material after the primary sintering was ground in an agate mortar for 5 min, and placed again in a tube furnace at 720° C. for sintering for 15 h, with the heating rate being 3° C./min and the oxygen flow being 100 mL/min. After the secondary sintering was finished, the temperature was naturally cooled, and when the furnace body was cooled to room temperature, the material subjected to the secondary sintering was removed, ground in an agate mortar for 5 min, and then sealed and transferred to a glove box for storage, so as to obtain a positive electrode material.

### Preparation of a Battery

A 2032 button battery was prepared using the same method as in Example 1.

### EXAMPLE 3

### Preparation of a Positive Electrode Material

3 g of Ni_{0.98}Co_{0.01}Mn_{0.01}(OH)₂ precursor, 1.47 g of lithium hydroxide monohydrate (the molar ratio of the precursor to lithium hydroxide monohydrate=1:1.06), and 0.0751 g of tungsten oxide (WO₃, the molar ratio of the precursor to tungsten oxide is 100:1.0) were mixed homogenously in an agate mortar. Firstly, the mixture was subjected to sintering in a tube furnace at 500° C. for 5 h at a heating rate of 3° C./min, and highly pure oxygen was introduced at an oxygen flow rate of 100 mL/min. After the primary sintering was completed, the temperature was naturally reduced, and when the furnace temperature was reduced to room temperature, the material after the primary sintering was removed. The material after the primary sintering was ground in an agate mortar for 5 min, and placed again in a tube furnace at 720° C. for sintering for 15 h, with the heating rate being 3° C./min and the oxygen flow being 100 mL/min. After the secondary sintering was finished, the temperature was naturally cooled, and when the furnace body was cooled to room temperature, the material subjected to the secondary sintering was removed, ground in an agate mortar for 5 min, and then sealed and transferred to a glove box for storage, so as to obtain a positive electrode material.

### Preparation of a Battery

A 2032 button battery was prepared using the same method as in Example 1.

### EXAMPLE 4

### Preparation of a Positive Electrode Material

3 g of Ni_{0.98}Co_{0.01}Mn_{0.01}(OH)₂ precursor, 1.47 g of lithium hydroxide monohydrate (the molar ratio of the precursor to lithium hydroxide monohydrate=1:1.06), and 0.1128 g of tungsten oxide (WO₃, the molar ratio of the precursor to tungsten oxide is 100:1.5) were mixed homogenously in an agate mortar. Firstly, the mixture was subjected to sintering in a tube furnace at 500° C. for 5 h at a heating rate of 3° C./min, and highly pure oxygen was introduced at an oxygen flow rate of 100 mL/min. After the primary sintering was completed, the temperature was naturally reduced, and when the furnace temperature was reduced to room temperature, the material after the primary sintering was removed. The material after the primary sintering was ground in an agate mortar for 5 min, and placed again in a tube furnace at 720° C. for sintering for 15 h, with the heating rate being 3° C./min and the oxygen flow being 100 mL/min. After the secondary sintering was finished, the temperature was naturally cooled, and when the furnace body was cooled to room temperature, the material subjected to the secondary sintering was removed, ground in an agate mortar for 5 min, and then sealed and transferred to a glove box for storage, so as to obtain a positive electrode material.

### Preparation of a Battery

A 2032 button battery was prepared using the same method as in Example 1.

### EXAMPLE 5

### Preparation of a Positive Electrode Material

3 g of Ni_{0.98}Co_{0.01}Mn_{0.01}(OH)₂ precursor, 1.47 g of lithium hydroxide monohydrate (the molar ratio of the precursor to lithium hydroxide monohydrate=1:1.06), and 0.1502 g of tungsten oxide (WO₃, the molar ratio of the precursor to tungsten oxide is 100:2.0) were mixed homogenously in an agate mortar. Firstly, the mixture was subjected to sintering in a tube furnace at 500° C. for 5 h at a heating rate of 3° C./min, and highly pure oxygen was introduced at an oxygen flow rate of 100 mL/min. After the primary sintering was completed, the temperature was naturally reduced, and when the furnace temperature was reduced to room temperature, the material after the primary sintering was removed. The material after the primary sintering was ground in an agate mortar for 5 min, and placed again in a tube furnace at 720° C. for sintering for 15 h, with the heating rate being 3° C./min and the oxygen flow being 100 mL/min. After the secondary sintering was finished, the temperature was naturally cooled, and when the furnace body was cooled to room temperature, the material subjected to the secondary sintering was removed, ground in an agate mortar for 5 min, and then sealed and transferred to a glove box for storage, so as to obtain a positive electrode material.

### Preparation of a Battery

A 2032 button battery was prepared using the same method as in Example 1.

### EXAMPLE 6

### Preparation of Positive Electrode Material

3 g of Ni_{0.98}Co_{0.01}Mn_{0.01}(OH)₂ precursor, 1.47 g of lithium hydroxide monohydrate (the molar ratio of the precursor to lithium hydroxide monohydrate=1:1.06), and 0.0466 g of molybdenum oxide (MoO₃, the molar ratio of the precursor to molybdenum oxide is 100:1.0) were mixed homogenously in an agate mortar. Firstly, the mixture was subjected to sintering in a tube furnace at 500° C. for 5 h at a heating rate of 3° C./min, and highly pure oxygen was introduced at an oxygen flow rate of 100 mL/min. After the primary sintering was completed, the temperature was naturally reduced, and when the furnace temperature was reduced to room temperature, the material after the primary sintering was removed. The material after the primary sintering was ground in an agate mortar for 5 min, and placed again in a tube furnace at 720° C. for sintering for 15 h, with the heating rate being 3° C./min and the oxygen flow being 100 mL/min. After the secondary sintering was finished, the temperature was naturally cooled, and when the furnace body was cooled to room temperature, the material subjected to the secondary sintering was removed, ground in an agate mortar for 5 min, and then sealed and transferred to a glove box for storage, so as to obtain a positive electrode material.

### Preparation of a Battery

A 2032 button battery was prepared using the same method as in Example 1.

### EXAMPLE 7

### Preparation of a Positive Electrode Material

3 g of Ni_{0.98}Co_{0.01}Mn_{0.01}(OH)₂ precursor, 1.47 g of lithium hydroxide monohydrate (the molar ratio of the precursor to lithium hydroxide monohydrate=1:1.06), and 0.0861 g of niobium oxide (Nb₂O₅, the molar ratio of the precursor to niobium oxide is 100:1.0) were mixed homogenously in an agate mortar. Firstly, the mixture was subjected to sintering in a tube furnace at 500° C. for 5 h at a heating rate of 3° C./min, and highly pure oxygen was introduced at an oxygen flow rate of 100 mL/min. After the primary sintering was completed, the temperature was naturally reduced, and when the furnace temperature was reduced to room temperature, the material after the primary sintering was removed. The material after the primary sintering was ground in an agate mortar for 5 min, and placed again in a tube furnace at 720° C. for sintering for 15 h, with the heating rate being 3° C./min and the oxygen flow being 100 mL/min. After the secondary sintering was finished, the temperature was naturally cooled, and when the furnace body was cooled to room temperature, the material subjected to the secondary sintering was removed, ground in an agate mortar for 5 min, and then sealed and transferred to a glove box for storage, so as to obtain a positive electrode material.

### Preparation of a Battery

A 2032 button battery was prepared using the same method as in Example 1.

### EXAMPLE 8

### Preparation of a Positive Electrode Material

3 g of Ni_{0.80}Co_{0.10}Mn_{0.10}(OH)₂ precursor, 1.47 g of lithium hydroxide monohydrate (the molar ratio of the precursor to lithium hydroxide monohydrate=1:1.06), and 0.0376 g of tungsten oxide (WO₃, the molar ratio of the precursor to tungsten oxide is 100:0.5) were mixed homogenously in an agate mortar. Firstly, the mixture was subjected to sintering in a tube furnace at 500° C. for 5 h at a heating rate of 3° C./min, and highly pure oxygen was introduced at an oxygen flow rate of 100 mL/min. After the primary sintering was completed, the temperature was naturally reduced, and when the furnace temperature was reduced to room temperature, the material after the primary sintering was removed. The material after the primary sintering was ground in an agate mortar for 5 min, and placed again in a tube furnace at 700° C. for sintering for 15 h, with the heating rate being 3° C./min and the oxygen flow being 100 mL/min. After the secondary sintering was finished, the temperature was naturally cooled, and when the furnace body was cooled to room temperature, the material subjected to the secondary sintering was removed, ground in an agate mortar for 5 min, and then sealed and transferred to a glove box for storage, so as to obtain a positive electrode material.

### Preparation of a Battery

A 2032 button battery was prepared using the same method as in Example 1.

### EXAMPLE 9

### Preparation of a Positive Electrode Material

3 g of Ni_{0.92}Co_{0.04}Mn_{0.04}(OH)₂ precursor, 1.47 g of lithium hydroxide monohydrate (the molar ratio of the precursor to lithium hydroxide monohydrate=1:1.06), and 0.0376 g of tungsten oxide (WO₃, the molar ratio of the precursor to tungsten oxide is 100:0.5) were mixed homogenously in an agate mortar. Firstly, the mixture was subjected to sintering in a tube furnace at 500° C. for 5 h at a heating rate of 3° C./min, and highly pure oxygen was introduced at an oxygen flow rate of 100 mL/min. After the primary sintering was completed, the temperature was naturally reduced, and when the furnace temperature was reduced to room temperature, the material after the primary sintering was removed. The material after the primary sintering was ground in an agate mortar for 5 min, and placed again in a tube furnace at 700° C. for sintering for 15 h, with the heating rate being 3° C./min and the oxygen flow being 100 mL/min. After the secondary sintering was finished, the temperature was naturally cooled, and when the furnace body was cooled to room temperature, the material subjected to the secondary sintering was removed, ground in an agate mortar for 5 min, and then sealed and transferred to a glove box for storage, so as to obtain a positive electrode material.

### Preparation of a Battery

A 2032 button battery was prepared using the same method as in Example 1.

### COMPARATIVE EXAMPLE 1

### Preparation of a Positive Electrode Material

3 g of Ni_{0.98}Co_{0.01}Mn_{0.01}(OH)₂ precursor and 1.47 g of lithium hydroxide monohydrate (the molar ratio of the precursor to lithium hydroxide monohydrate=1:1.06) were mixed homogenously in an agate mortar. Firstly, the mixture was subjected to sintering in a tube furnace at 500° C. for 5 h at a heating rate of 3° C./min, and highly pure oxygen was introduced at an oxygen flow rate of 100 mL/min. After the primary sintering was completed, the temperature was naturally reduced, and when the furnace temperature was reduced to room temperature, the material after the primary sintering was removed. The material after the primary sintering was ground in an agate mortar for 5 min, and placed again in a tube furnace at 720° C. for sintering for 15 h, with the heating rate being 3° C./min and the oxygen flow being 100 mL/min. After the secondary sintering was finished, the temperature was naturally cooled, and when the furnace body was cooled to room temperature, the material subjected to the secondary sintering was removed, ground in an agate mortar for 5 min, and then sealed and transferred to a glove box for storage, so as to obtain a positive electrode material NCM98.

### Preparation of a Battery

A 2032 button battery was prepared using the same method as in Example 1.

### Test of Battery Properties

### Measurement of the First Charge/Discharge Specific Capacity (mAh·g⁻¹) and the Specific Capacity after 100 Cycles

The batteries prepared in the described Examples and Comparative Examples were tested. The batteries were cycled for one cycle at 30° C. and in a voltage range of 2.0-4.25 V, and the charging and discharging currents were both 0.1 C (20 mA·g⁻¹). Then, the batteries were cycled for 100 cycles at 60° C. and in a voltage range of 2.5-4.25 V, and the charging and discharging currents were 1 C and 5 C, respectively.

The experimental results are shown in Table 1.

### Determination of the Coulombic Efficiency of the First Cycle

The efficiency of the first cycle of the lithium ion secondary battery produced by each example and each comparative example was calculated by the following calculation formula:

Efficiency of the first cycle=first discharging capacity/first charging capacity×100%.

The experimental results are shown in Table 1.

### Measurement of the Composition of the Positive Electrode Material

The compositions of the positive electrode materials prepared in the examples and comparative examples described were analyzed and measured. The compositions were respectively measured using an inductively coupled plasma-optical emission spectrometry (ICP-OES), and the test results are shown in Table 2.

### Microscopic Analysis of the Positive Electrode Material

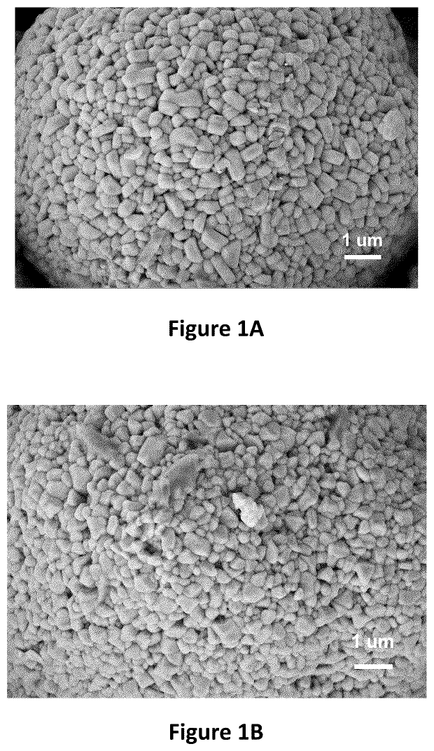

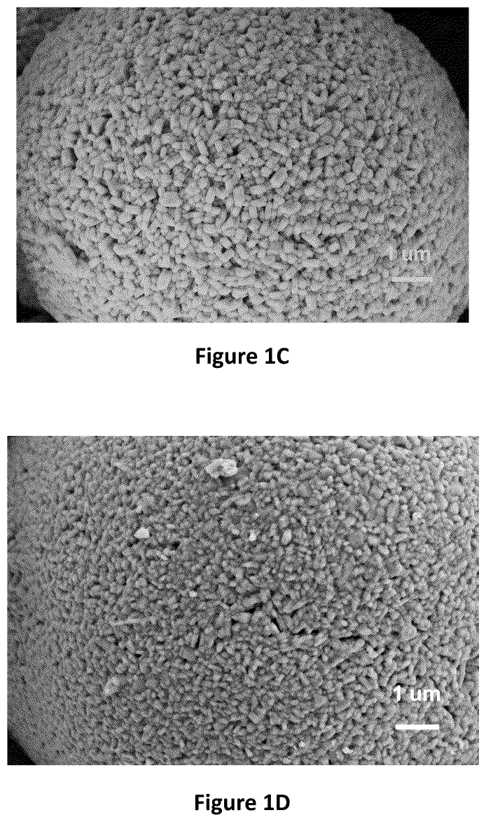

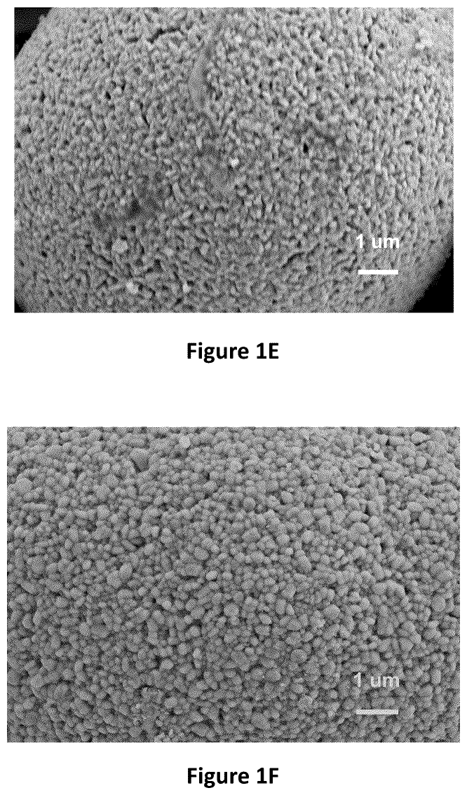

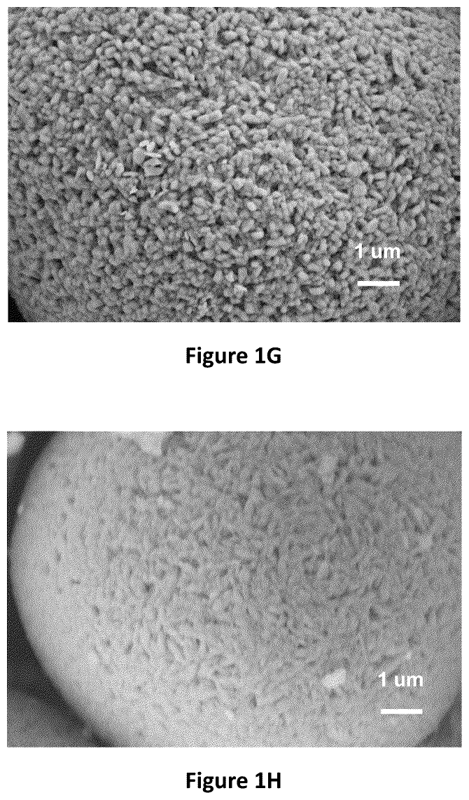

Images were generated using SEM (SEM test instrument manufacturer: Zeiss, model: SUPRA55 SAPPHIRE) on the positive electrode materials prepared in the described examples and comparative examples, respectively, and the results of the images are shown in FIGS. 1A to 11 and FIG. 2.

### Distribution Analysis of the Modifying Material in the Phase of the Positive Electrode Material

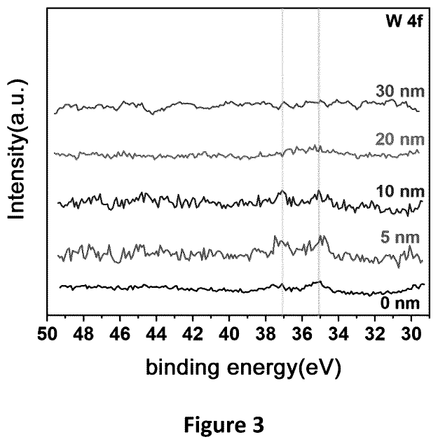

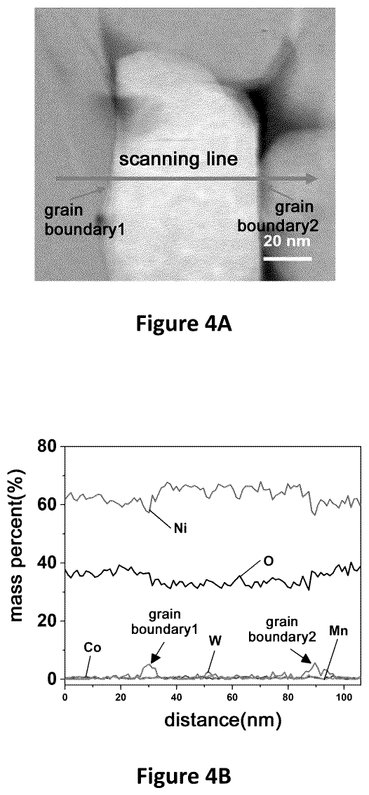

The positive electrode material prepared in Example 3 was analyzed using XPS (XPS test instrument manufacturer: Thermo Fisher, model: Escalab Xi+), and the results thereof are shown in FIG. 3. The weight distribution of elements in the positive electrode material prepared in Example 3 was observed and tested using STEM, and the results of the experiment are shown in FIG. 4.

### Particle Size Analysis

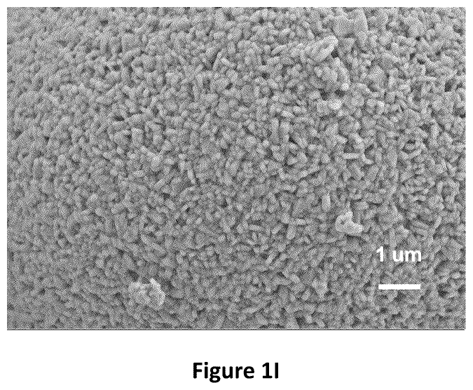

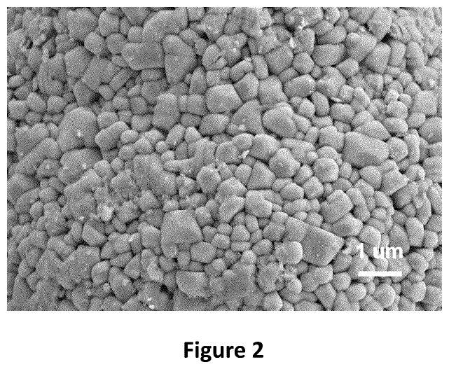

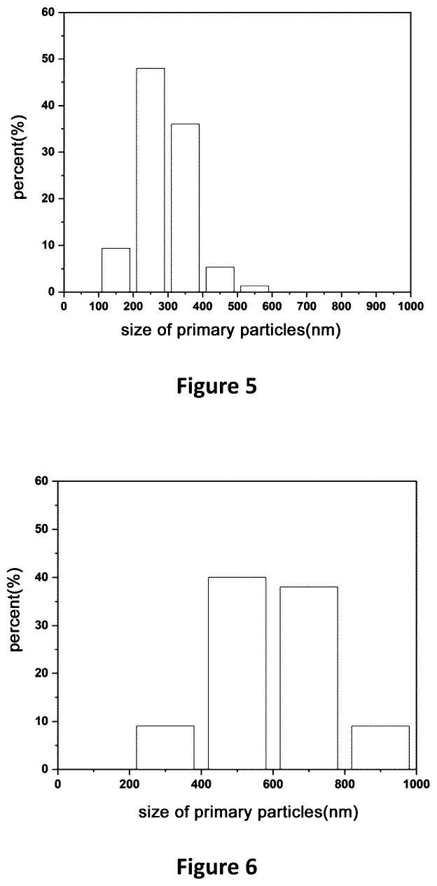

The particle sizes of the positive electrode materials prepared in Example 3 and Comparative Example 1 were respectively analyzed, the particle size distribution measurement software was Nano measure, and the particle size was observed by SEM. The SEM image of Example 3 is shown in FIG. 1C, and the SEM image of Comparative Example 1 is shown in FIG. 2. The results of the particle size distribution test are shown in FIG. 5 and FIG. 6.

### Mechanical Strength Analysis

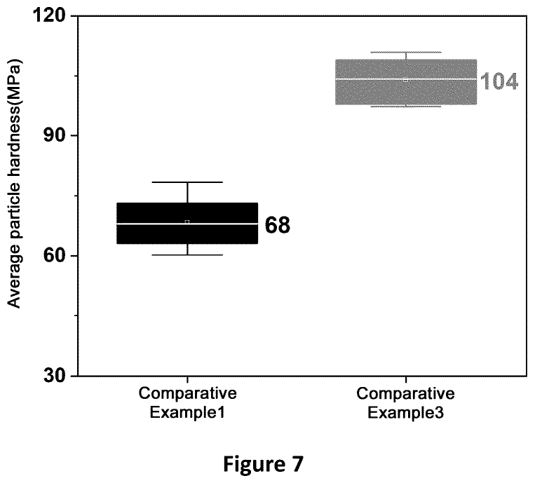

The positive electrode materials prepared in Example 3 and Comparative Example 1 were respectively analyzed for hardness using a microcompression test instrument (microcompression test instrument manufacturer: Shimadzu, model: MCT-510). The experimental results are shown in FIG. 7.

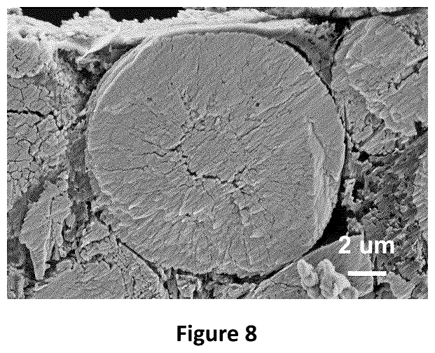

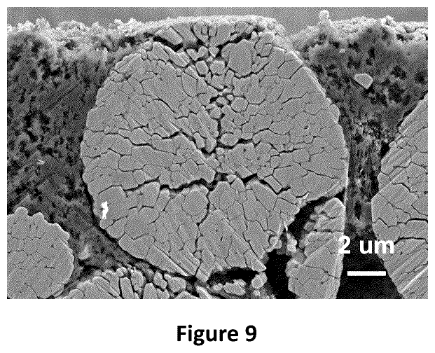

The batteries prepared in Example 3 and Comparative Example 1 were subjected to cycle test as described above, and the cycle test was stopped after 100 cycles, wherein the cycle conditions were as follows: 60° C., charging at 1 C, discharging at 5 C, cycling for 100 cycles at 2.5-4.25 V. The batteries prepared in Example 3 and Comparative Example 1 were disassembled to obtain positive electrode materials, respectively, and then the positive electrode materials after 100 cycles were observed using SEM (SEM (SEM test instrument manufacturer: Zeiss, model: SUPRA55 SAPPHIRE). The results are shown in FIGS. 8 and 9.

### Impedance Test

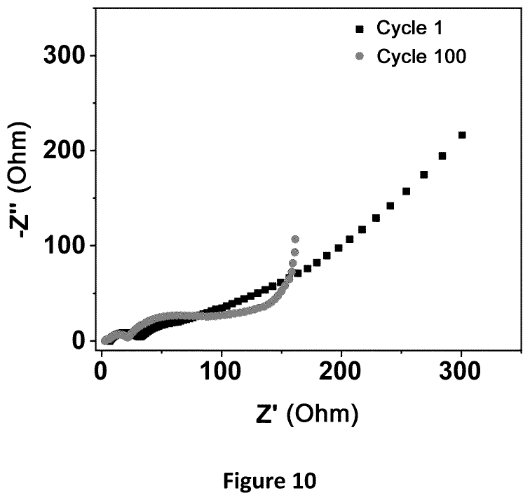

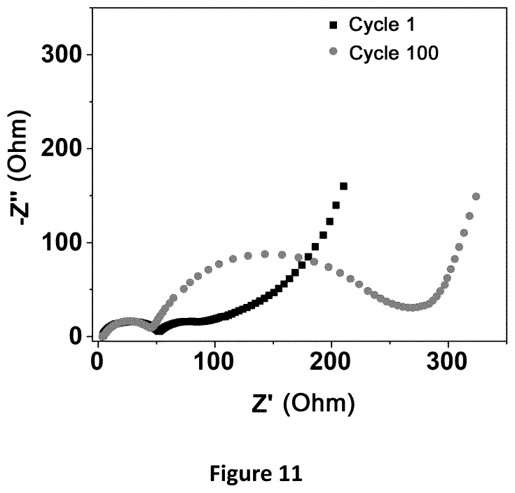

The batteries prepared in Example 3 and Comparative Example 1 were tested for impedance using an EIS test instrument (EIS test instrument manufacturer: Shanghai Chenhua, model: CHI760E), wherein the rated cycling conditions for the batteries were as follows: 60° C., charging at 1 C, discharging at 5 C, and cycling at 2.5-4.25 V for 100 cycles; and the experimental conditions for the impedance test were as follows: room temperature, battery voltage about 4.25 V, and frequency 10⁻³ Hz to 10⁵ Hz. The experimental results are shown in FIGS. 10 and 11.

TABLE 1

| | | | | initial | | capacity |
|---|---|---|---|---|---|---|
| | | | initial | dis- | | (mAh · |
| | | | charge | charge | | g⁻¹) at |
| | | | capacity | capacity | | 60 °C |
| | | | (mAh · | (mAh · | coulombic | after |
| | | doping | g⁻¹) | g⁻¹) | efficiency | 100 |
| | | amount | at 0.1 C | at 0.1 C | at first | cycles |
| | | (mol | and | and | cycle | at |
| sample | dopant | %) | 30° C. | 30° C. | (%) | 1 C/5 C |
| Example 1 | WO₃ | 0.25 | 240.0 | 228.2 | 96.1 | 154 |
| Example 2 | WO₃ | 0.5 | 241.1 | 233.1 | 96.7 | 168 |
| Example 3 | WO₃ | 1.0 | 239.8 | 230.5 | 96.1 | 190 |
| Example 4 | WO₃ | 1.5 | 231.3 | 206.0 | 89.1 | 185 |
| Example 5 | WO₃ | 2.0 | 231.5 | 207.8 | 89.7 | 178 |
| Example 6 | MoO₃ | 1.0 | 244.5 | 232.1 | 94.9 | 188 |
| Example 7 | Nb₂O₅ | 1.0 | 241.1 | 226.6 | 94.0 | 188 |
| Example 8 | WO₃ | 0.5 | 202.4 | 181.0 | 89.4 | 143 |
| Example 9 | WO₃ | 0.5 | 212.6 | 174.5 | 82.1 | 180 |
| Comparative | None | 0 | 250.6 | 233.7 | 93.3 | 119 |
| Example 1 | | | | | | |

As can be determined from the experimental results shown in Table 1 above, in the case where the positive electrode material was prepared using the method of the present application, both the coulombic efficiency of the first cycle and the capacity after 100 cycles of the battery were significantly improved. As can be determined by comparing Examples 1-5, the coulombic efficiency of the batteries of the first cycle could reach 96.1% with the addition of 1.0 mol % of tungsten oxide, and its capacity could reach the surprising 190 mAh·g⁻¹ after 100 cycles. Compared with Comparative Example 1 (without the addition of a dopant), the coulombic efficiency of the first cycle or the capacity after 100 cycles of the battery of the present application are both significantly improved.

TABLE 2

| | chemical composition (atom %) | | | doped element | | |
|---|---|---|---|---|---|---|
| sample | Ni | Co | Mn | W | Mo | Nb |
| Example 1 | 98.046 | 1.053 | 0.902 | 0.255 | — | — |
| Example 2 | 98.076 | 1.038 | 0.886 | 0.549 | — | — |
| Example 3 | 98.034 | 1.052 | 0.913 | 1.069 | — | — |
| Example 4 | 98.025 | 1.037 | 0.938 | 1.495 | — | — |
| Example 5 | 98.040 | 1.042 | 0.918 | 2.042 | — | — |
| Example 6 | 98.040 | 1.050 | 0.909 | — | 1.036 | — |
| Example 7 | 98.032 | 1.043 | 0.924 | — | — | 1.042 |
| Example 8 | 80.362 | 9.926 | 9.712 | 0.536 | — | — |
| Example 9 | 92.248 | 3.934 | 3.818 | 0.528 | — | — |
| Comparative | 98.127 | 1.034 | 0.839 | — | — | — |
| Example 1 | | | | | | |

Table 2 shows element compositions of the positive electrode materials of Examples 1-9 and Comparative Example 1, wherein it can be determined from ICP-OES analysis of the positive electrode materials prepared in Examples 1-9 that the doping amount of the transition metal (W, Mo or Nb) was in the range of about 0.25 atom % to about 2 atom %.

As can be determined from the SEM results of FIG. 1A to FIG. 1I that the positive electrode material of the present application contains a plurality of primary particles, and these primary particles are agglomerated into polycrystalline particle spheres. An SEM image of the positive electrode material prepared in Comparative Example 1 is shown in FIG. 2, and it can be determined clearly from comparison between FIG. 2 and FIGS. 1A to 1I that the primary particles of the positive electrode material of the present application have a smaller size.

FIG. 3 shows XPS test results of the positive electrode material prepared in Example 3 of the present application, wherein the positive electrode material of Example 3 is doped with 1% of tungsten oxide. It can be determined from the XPS results that the tungsten element (indicated by two vertical lines in FIG. 3) has distinct peaks on the surface of the positive electrode material and at 5 nm, 10 nm, and 20 nm, and has no characteristic peak at 30 nm. Therefore, it can be determined that the doping depth of the transition metal (e.g., tungsten element) of the present application is in the range of 0 nm to 20 nm. FIG. 4B shows STEM-EDS elemental line scan results of the positive electrode material according to Example 3 of the present application. It can be determined from FIG. 4A that scanning is performed along a scanning line from grain boundary 1 to grain boundary 2. In FIG. 4B, two grain boundary peaks appear at grain boundaries 1 and 2. At the two grain boundary peaks, the content of the tungsten element is obviously higher than that in other positions, indicating that W is enriched at the grain boundaries. Therefore, it indicates that in the positive electrode material of the present application, the modifying material (e.g., tungsten element) is enriched at the grain boundary interfaces between the primary particles.

FIG. 5 shows measurement results of the particle size distribution of the primary particles of the positive electrode material according to Example 3 of the present application. FIG. 6 shows the measurement results of the particle size distribution of the primary particles of the positive electrode material of Comparative Example 1. From the results of FIGS. 5 and 6 and with reference to FIGS. 1C and 2, it can be determined that the size of about 90% of the primary particles in the positive electrode material of the present application is in the range of 200 nm to 400 nm, wherein the size of about 47% of the primary particles is in the range of 200 nm to 300 nm, the size of about 35% of the primary particles is in the range of 300 nm to 400 nm, and the average particle size of the primary particles is about 290 nm; and in Comparative Example 1, about 96% of the primary particles in the positive electrode material to which the modifying material is not added have a size of 300 nm to 900 nm, in which about 90% or more of the primary particles have a particle size of 400 nm or more (far greater than the range of less than 400 nm in the present application), and the primary particles have an average particle size of 600 nm.

FIG. 7 shows the results of measurement of hardness of Example 3 of the present application and Comparative Example 1. The average particle hardness of the positive electrode material of Example 3 (doping amount of 1%) of the present application is 104 MPa, while the average particle hardness of the undoped Comparative Example 1 is 68 MPa, and thun the hardness of the positive electrode material is improved by about 50%. In addition, it can also be determined from SEM images of the cross sections of the materials in FIG. 8 and FIG. 9 that after 100 cycles of the grains, the structural integrity of the positive electrode material of the Example 3 of the present application is well maintained, and no obvious deformation or decomposition occurs, while severe grain breaking has occurred in the positive electrode material of Example 1.

FIG. 10 shows the increase in the charge transfer impedance of the battery according to Example 3 of the present application after 100 cycles. FIG. 11 shows the increase in the charge transfer impedance of the battery of Comparative Example 1 after 100 cycles. It is shown in FIG. 11 that the charge transfer resistance (R_{ct}) of the undoped positive electrode material (Comparative Example 1) increases almost 3 times (increasing from 55 Ω to 215 Ω) after 100 cycles, while the charge transfer resistance (R_{ct}) of the positive electrode material (1% tungsten doping) of Example 3 of the present application increases only 10% (increasing from 80 Ω to 88 Ω) after 100 cycles. As the positive electrode material of the present application has a significantly reduced impedance value after cycling, it can ensure a high capacity of the battery after 100 cycles.

The described description is only the preferred examples of the present application, and is not intended to limit the present application. For those skilled in the art, the present application may have various modifications and variations. Any modifications, equivalent replacements, improvements and the like made within the spirit and principle of the present application shall belong to the protection scope of the present application.

1. A positive electrode material for a lithium ion secondary battery, comprising:
polycrystalline particles of a ternary positive electrode material, comprising a plurality of primary particles; and
a modifying material located on the surface of the polycrystalline particles and/or at the grain boundary interfaces between the primary particles, wherein the modifying material comprises an oxide of a positive pentavalent or positive hexavalent transition metal.

2. The positive electrode material of claim 1, wherein the modifying material comprises tungsten oxide, niobium oxide, or molybdenum oxide.

3. The positive electrode material of claim 1, wherein the primary particles have a particle size of about 400 nm or less.

4. The positive electrode material of claim 1, wherein the average particle size of the primary particles is in the range of about 250 nm to about 350 nm.

5. The positive electrode material of claim 1, wherein the ternary positive electrode material has a chemical general formula LiNiₓCo_{y}Mn_{1-x-y}O₂, wherein 0.8≤x<1, 0<y<1, and 0<x+y<1.

6. The positive electrode material of claim 5, wherein the ternary positive electrode material has a chemical general formula LiNiₓCo_{y}Mn_{1-x-y}O₂, wherein 0.9≤x<1, 0<y<1, and 0<x+y<1.

7. The positive electrode material of claim 1, wherein the doping depth of the modifying material is in the range of about 0 nm to about 20 nm.

8. The positive electrode material of claim 1, wherein the doping amount of the transition metal in the positive electrode material is in the range of about 0.25 atom % to about 2.1 atom %, based on the total number of atoms of the positive electrode material.

9. A method for preparing the positive electrode material for a lithium ion secondary battery, comprising the following steps:
step S1, subjecting a lithium source, a ternary positive electrode material precursor, and a modifying material to primary sintering, wherein the modifying material comprises an oxide of a positive pentavalent or positive hexavalent transition metal; and
step S2, grinding the product after the primary sintering, and subjecting the ground product to secondary sintering, wherein the temperature of the primary sintering is lower than the temperature of the secondary sintering.

10. The method of claim 9, wherein the ternary positive electrode material precursor is [NiₓCo_{y}Mn_{1-x-y}](OH)₂, wherein 0.8≤x<1, 0<y<1, and 0<x+y<1.

11. The method of claim 10, wherein the ternary positive electrode material precursor is [NiₓCo_{y}Mn_{1-x-y}](OH)₂, wherein 0.9≤x<1, 0<y<1, and 0<x+y<1.

12. The method of claim 9, wherein the modifying material comprises tungsten oxide, niobium oxide, or molybdenum oxide.

13. The method of claim 9, wherein the molar ratio of the ternary positive electrode material precursor to the modifying material is in the range of 100:0.25 to 100:2.0.

14. The method of claim 9, wherein the primary sintering is performed for about 4 to about 7 hours in a temperature range of about 450° C. to about 600° C., and oxygen gas is introduced at a flow rate of about 80 ml/min to about 150 ml/min during the primary sintering.

15. The method of claim 9, wherein the secondary sintering is performed in a temperature range of about 700° C. to about 800° C. for about 12 to about 20 hours, and oxygen gas is introduced at a flow rate of about 80 ml/min to about 150 ml/min during the secondary sintering.

16. The method of claim 9, wherein the lithium source comprises lithium hydroxide or lithium carbonate.

17. The method of claim 9, wherein the molar ratio of the ternary positive electrode material precursor to the lithium source is in the range of 1:1 to 1:1.2.
